(19) United States
(12) Patent Application Publication
(10) Pub. No.: US 2016/0307100 A1
(43) Pub. Date: Oct. 20, 2016

(54) SYSTEMS AND METHODS FOR INTELLIGENT ALERT FILTERS

(71) Applicant: General Electric Company, Schenectady, NY (US)

(72) Inventors: Jennifer Ruth Cooper, San Ramon, CA (US); Benjamin James Sykes, San Ramon, CA (US)

(21) Appl. No.: 14/691,235

(22) Filed: Apr. 20, 2015

(51) Int. Cl. G06N 5/02; G06F 3/0484

(52) U.S. Cl. CPC G06N 5/025; G06F 3/0484

(57) ABSTRACT

A system and method of generating intelligent alerts based on updatable rules, filters, or algorithms, the method includes receiving one or more device status messages from sensors monitoring devices of a monitored system, determining an alert priority for each of the one or more device status messages, storing the alert priority, the respective device status message, and associated metadata in a data store, providing an alert message to an interactive user interface, the alert message indicating the alert priority, monitoring a user's interaction with the alert message, classifying the user's interaction with the alert message, storing the user's interaction correlated with the corresponding alert message in a data store, analyzing the user's interaction to develop correlations between a cause of respective device status message, its associated data, and the user's interaction, and updating a data store with the correlation. A system and non-transitory computer readable medium are also disclosed.

### BACKGROUND

Modern equipment (e.g., appliances, engines, machines, locomotives, generators, etc.) have evolved into extremely complicated devices. These devices can include sophisticated computer systems that monitor the performance of the devices themselves. The more sophisticated and intricate devices can include monitors that report on the status of many components within the device. These reports can include error alerts.

The error alerts can be reported to a system administrator and/or user by some sort of electronic communication (e.g., e-mail, text message, website posting, queue list, etc.). This list of alerts needs to be handled in a timely fashion. In some cases the alert can be reporting on a mission-critical status (e.g., aircraft engine failure); other alerts could be less crucial but still require attention (e.g., aircraft lavatory failure).

The extent of alerts can encompass every system on-board the piece of equipment. For example, on-board aircraft alerts can come from diverse systems such as communications, navigation, flight systems, flight control, collision avoidance, weather radar, etc.

Conventional analytics of the alert messages can consider predefined concepts about how an event in the data needs to be handled. However, these predefined concepts often do not consider hard to define, and difficult to capture, information—such as domain knowledge, rare events, anomalies, and other occurrences that can affect the way an alert or event should be managed. Conventional alert management systems do not include these types of information in their analytic logic. Additionally, conventional systems do not improve their analytic logic using feedback and lessons-learned based on how the alerts are handled by users.

### BRIEF DESCRIPTION OF THE DRAWINGS

FIG. 1 depicts a system in accordance with some embodiments; and

FIGS. 2A-2B depict a flow diagram of an intelligent alert filter process in accordance with some embodiments.

### DETAILED DESCRIPTION

In accordance with embodiments, systems and methods provide one or more intelligent alert filters (IAF) that apply machine-learning, artificial intelligence, and/or heuristic techniques to create, and/or improve, alert-handling rules based on how the alerts are handled by users over time. Embodying systems and methods monitor and classify the data associated with alerts, and the corresponding actions users took on respective alerts. Based on correlating evidence in the data obtained from the monitoring and classification, a determination of the users' probable reasoning behind the decisions can be deduced. Embodying systems and methods can then categorize future alerts by applying updated rules and/or algorithms incorporating this perceived reasoning.

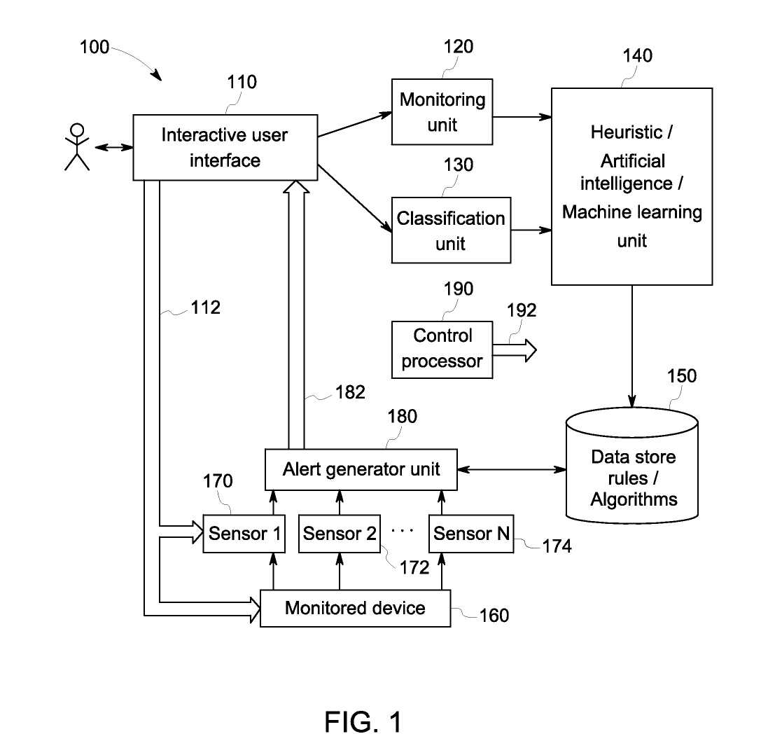

FIG. 1 depicts intelligent alert filter system 100 in accordance with some embodiments. IAF system 100 includes alert generator unit 180. The alert generator unit receives information from one or more sensors sensor 1 170, sensor 2 172, . . . , sensor N 174 that are configured to monitor monitored device 160.

Sensors sensor 1, sensor 2, . . . , sensor N and monitored device 160 need not be part of the intelligent alert system, but simply provide information to the alert generator unit. The monitored system itself can be of any nature and/or type (for example, appliances, locomotives, jet engines, generators, machinery, cellular phones, engines, vehicles (automotive, airborne, space), turbines, appliances, medical telemetry, industrial process plant, etc.). The sensor devices monitor the status of various conditions of the monitored device. It is this status that the sensor provides to alert generator unit 180.

Under direction of control processor 190 via communication across bus 192, alert generator unit 180 accesses rules and/or algorithms stored in data store 150. In accordance with some embodiments, alert generator 180 can react to incoming status condition data from one or more sensors without direct control from control processor 190. The rules and/or algorithms are applied by the alert generator unit to the status conditions provided by the sensor devices to determine whether an alert message is deemed appropriate—e.g., if the monitored device is in an alert condition. The alert generator unit can generate an alert message across bus 182 to interactive user interface 110. The system does not block alerts, but does filter and/or classify the alert, and possibly take action based on a determination made from application of the rules and/or algorithms. Alerts, and any corresponding action are recorded.

In one implementation the alert generator unit can be part of an analytic and monitoring system. An additional unit could automatically attempt to classify alerts using the rules and/or algorithms stored in data store 150, and take action. The action would be determined based on the rules and/or algorithms based on the classification results having a confidence rating above a pre-determined threshold indicating that the correct action has been determined. If the threshold is not met, a classification can be presented to the user along with a set of possible actions, or the alert can remain unclassified if there are no applicable rules and/or algorithms.

In accordance with implementations, interactive user interface 110 can be of different forms. For example, but not limited to, an e-mail list, an instant message queue, a display panel queue, a web-based listing, etc. A user can interact with alert messages posted on the interactive user interface. In accordance with some embodiments, an alert queue can be a streaming feed where new alerts appear for the user to take action. The user can select the new alert for more details.

In accordance with some embodiments, a user can make an informed decision on the disposition of an alert by examining details of the alert message. The alert message can include, but is not limited to, one or more of the following details: (a) the data source that caused the alert; (b) any supporting information for that alert type; and/or (c) any generic supporting information for the system.

For example, if a jet engine were to have what is commonly known as a cold start (i.e., after start-up, the engine does not reach predefined temperatures), then the temperature sensor reading that triggered the alert (i.e., the data source for the alert) could be shown to the user, and in one implementation, along with the datum point(s) in question. The user could also be presented with other data (i.e., alert's supporting information) associated with an engine start—for instance, turbine speeds. Finally, the user may be presented with the generic supporting data associated with the system, which in the case of an aircraft could be the time and date of the startup, and the flights departure and arrival airports.

In accordance with embodiments, the data provided along with the alert need not be the raw data streamed from the sensor. The user interface may provide the required data in a format that will best support the user's decision making skills (as predefined when the alerts are created). So in the example above, the temperature data provided may not be the raw sensor data, but a calculated stream—for example the difference in temperature between this particular engine start up and the engines start up temperatures in the recent past.

The user may use the source data and supporting data to decide whether there is an issue with this alert. In the cases where the user determines there is no issue, the system could compare this alert to previous examples of false positives and look for correlation. In the example used above, the user may see that the aircraft was taking off at an airport with a particularly high altitude, and therefore a lower than average outside air temperature. This, along with the supporting data which shows that the other aspects of the engine start up were normal, would lead the user to believe that the alert is a false positive. The system could then be able to compare this to previous false positives, find a correlation for this type of alert at this airport, and flag the alert as a suspected false positive due to aircraft location and/or outside air temperature.

The user's interaction with the alert message can be monitored by monitoring unit 120 and classification unit 130. Results of monitoring and classifying the user's interactions with the alert messages are forwarded to heuristic/artificial intelligence/machine learning (HAIML) unit 140.

Classification unit 130 applies rules and/or algorithms to the user's action and the sensor inputs to determine why the user selected that particular action. HAIML unit 140 builds rules by creating a history correlating user's action(s) and sensor data. This history can them be used heuristically to build and/or update the rules or algorithms for later use in classifying newly-generated alerts. Monitoring unit 120 can capture a user's interaction with the user interface. For example, keystrokes, value selection, details accessed by a user, etc. to gather data on what was important in determining the action. The user's interaction can include, but is not limited to, dismissing the alert, taking a specific action, forwarding to another party, canceling the alert, or other action. For example, the user can take action on the alert by sending instruction to the monitored device and/or sensor devices via bus 112. In accordance with some implementations, the user can communicate via electronic communication(s) with other personnel (e.g., maintenance crew, repair technician, parts/logistic personnel) to inform them on the device status and any remedial action to be taken.

With regard to HAIML unit 140, the particular details of the rules and/or algorithms that are developed are centric to the characteristics of the monitored device and the nature of the alert messages. Many different types of rules and/or algorithms can be developed by the HAIML unit. The user's actions are analyzed by the HAIML unit. The analysis can develop intelligent filters that can be retained by the system in data store 150 for later use when the same, or similar, alert message appears on interactive user interface 110.

Each of the above units of IAF system 100 can be directed under the control of control processor 190 via bus 192. The control processor can be configured to execute executable instructions that when executed may instruct and/or cause a controller or processor to perform methods disclosed herein.

In accordance with embodiments, IAF system 100 is configured to capture the hard to define, and difficult to capture, information that can affect the way an alert or event should be managed. The captured information can include domain knowledge, rare events, anomalies, and other occurrences. Domain knowledge can be captured by monitoring the action of the source of this knowledge—i.e. the users of the system. By analyzing a user's action taken and coming to a conclusion about why these action may have been taken, the IAF can automatically incorporate this knowledge over time into the alert queue. Incorporating the knowledge into the alert queue can aid the user by providing a better insight into which alerts are true, and which are nuisances; while also providing feedback into the disposition of similar alerts in the past. Providing this information and feedback can reduce the user's workload by removing unnecessary alerts, redirecting their focus onto important events, and providing the user with decisional support in the disposition of these events.

Embodying systems and methods utilize a user's decisions as input to HAIM unit 140. This input is used to develop, refine, and recalibrate rules, algorithms, and filters used by IAF system 100 in handling the alert messages. The HAIM unit learns from how alerts are categorized/treated by users. The updated and/or new rules, algorithms, and filters are used to determine what action to take for alerts. In accordance with embodiments, the updated and/or new rules, algorithms, and filters categorize alert messages based upon users' prior actions and decisions, not a pre-determined set of actions.

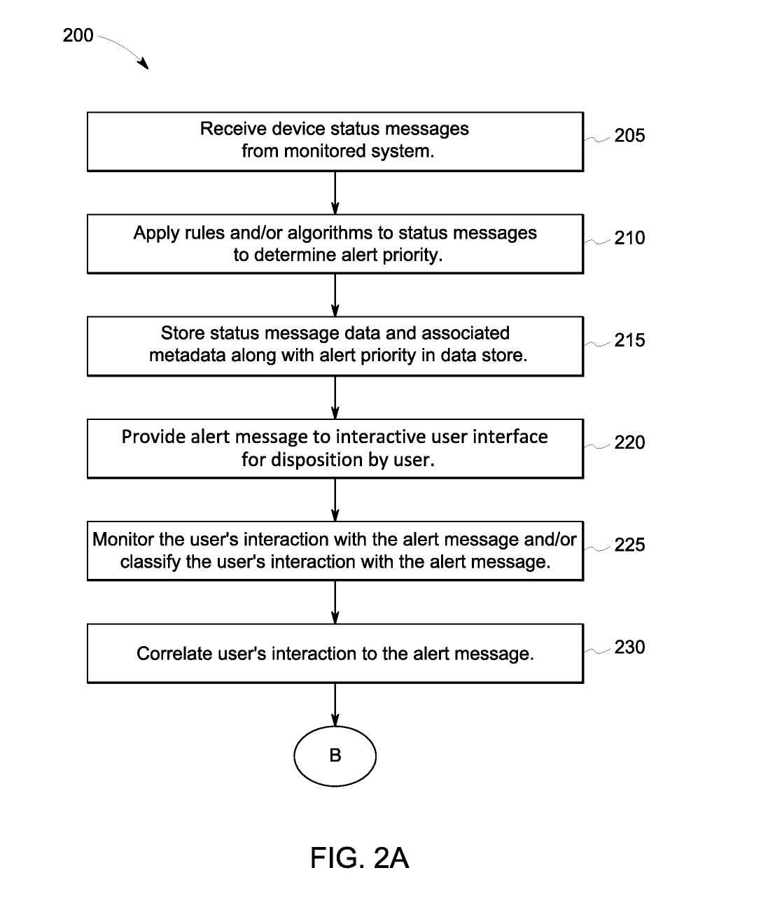

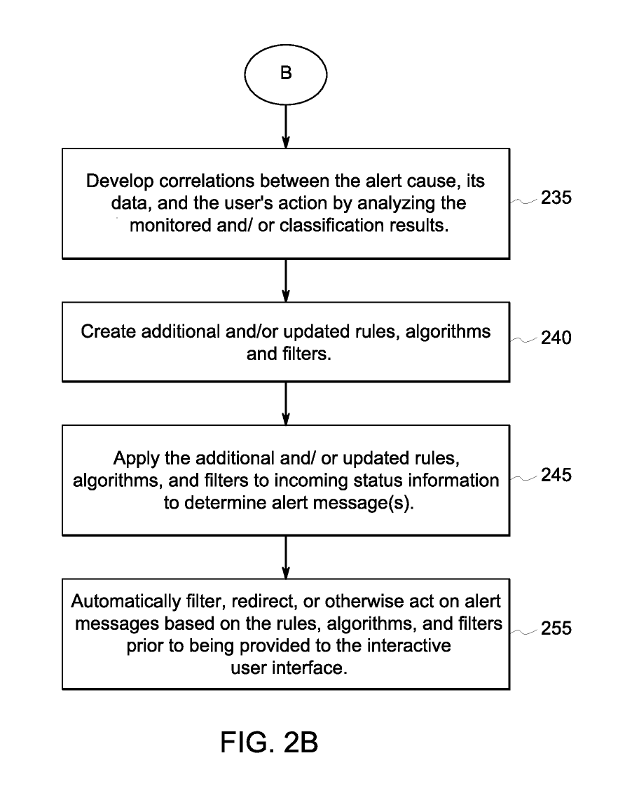

FIGS. 2A-2B depict a flow diagram of IAF process 200 in accordance with some embodiments. IAF process 200 receives status messages, applies rules, algorithms, and/or filters and creates alert messages that are provided to an interactive user interface. The IAF process monitors and classifies the user's actions, and uses this information to update, or create new, rules, algorithms and/or filters that are then used by the IAF process to analyze later status messages.

In accordance with embodiments, device status messages from sensors monitoring a device are received, step 205, by an alert generator unit. The alert generator unit applies, step 210, rules, algorithms, and/or filters to the status messages. An alert priority can be assigned to the alert message.

Information from the status message (e.g., message data, metadata, etc.) and alert priority is stored, step 215, in a data store. The alert message is provided, step 220, to an interactive user interface.

The user's interaction with the alert message is monitored and classified/categorized, step 225, by a monitoring unit and a classification unit. The user's interaction is stored, step 230, in a data store. In accordance with implementations, this information is correlated to the alert message and the stored information from the status message.

The monitored and classified/categorized information regarding the user's interaction with the alert message is analyzed, step 235. This analysis is used by the HAIM unit to develop correlations between the alert's cause, its data, and the user's action/response to the alert message.

The analysis results are used to create, step 240, additional and/or updated rules, algorithms, and/or filters, which can be stored in the data store. These additional and/or updated rules, algorithms, and/or filters are applied, step 245, to incoming status information by the alert generator unit. Based on the application of the rules, algorithms, and/or filters, alert messages are automatically, step 255, filtered, redirected, or otherwise acted on prior to providing the alert message to the interactive user interface.

In accordance with some embodiments, a computer program application stored in non-volatile memory or computer-readable medium (e.g., register memory, processor cache, RAM, ROM, hard drive, flash memory, CD ROM, magnetic media, etc.) may include code or executable instructions that when executed may instruct and/or cause a controller or processor to perform methods discussed herein such as a method for intelligent alert filter processing and rule updating, as described above.

The computer-readable medium may be a non-transitory computer-readable media including all forms and types of memory and all computer-readable media except for a transitory, propagating signal. In one implementation, the non-volatile memory or computer-readable medium may be external memory.

Although specific hardware and methods have been described herein, note that any number of other configurations may be provided in accordance with embodiments of the invention. Thus, while there have been shown, described, and pointed out fundamental novel features of the invention, it will be understood that various omissions, substitutions, and changes in the form and details of the illustrated embodiments, and in their operation, may be made by those skilled in the art without departing from the spirit and scope of the invention. Substitutions of elements from one embodiment to another are also fully intended and contemplated. The invention is defined solely with regard to the claims appended hereto, and equivalents of the recitations therein.

1. A method of generating intelligent alerts, the method comprising:
receiving one or more device status messages from sensors monitoring devices of a system;
determining an alert priority for each of the one or more device status messages;
storing the alert priority, the respective device status message, and associated metadata in a data store;
providing an alert message to an interactive user interface, the alert message indicating the alert priority;
monitoring a user's interaction with the alert message;
classifying the user's interaction with the alert message;
storing the user's interaction correlated with the corresponding alert message in a data store;
analyzing the user's interaction to develop correlations between a cause of respective device status message, its associated data, and the user's interaction; and
updating a data store with the correlation.

2. The method of claim 1, the determining step including applying rules, filters, or algorithms associated with the monitored device.

3. The method of claim 2, including updating the rules, filters, or algorithms based on respective ones of the correlations

4. The method of claim 3, including applying the updated rules, filters, or algorithms to respective ones of the device status messages.

5. The method of claim 1, the analyzing step including analyzing the classification of the user's interaction.

6. The method of claim 1, including automatically acting on a device status message prior to providing the alert message to the interactive user interface.

7. A non-transitory computer-readable medium having stored thereon instructions which when executed by a processor cause the processor to perform a method of generating intelligent alerts, the method comprising:
receiving one or more device status messages from sensors monitoring devices of a system;
determining an alert priority for each of the one or more device status messages;
storing the alert priority, the respective device status message, and associated metadata in a data store;
providing an alert message to an interactive user interface, the alert message indicating the alert priority;
monitoring a user's interaction with the alert message;
classifying the user's interaction with the alert message;
storing the user's interaction correlated with the corresponding alert message in a data store;
analyzing the user's interaction to develop correlations between a cause of respective device status message, its associated data, and the user's interaction; and
updating a data store with the correlation.

8. The non-transitory computer-readable medium of claim 7, including instructions to cause the processor to perform the determining step by including applying rules, filters, or algorithms associated with the monitored device.

9. The non-transitory computer-readable medium of claim 8, including instructions to cause the processor to perform updating the rules, filters, or algorithms based on respective ones of the correlations

10. The non-transitory computer-readable medium of claim 9, including instructions to cause the processor to perform applying the updated rules, filters, or algorithms to respective ones of the device status messages.

11. The non-transitory computer-readable medium of claim 7, including instructions to cause the processor to perform the analyzing step by including analyzing the classification of the user's interaction.

12. The non-transitory computer-readable medium of claim 7, including instructions to cause the processor to perform the step of automatically acting on a device status message prior to providing the alert message to the interactive user interface.

13. A system for generating intelligent alert filters, the system comprising:
an alert generating unit configured to receive one or more device status messages from sensors monitoring devices of a monitored system;
a control processor configured to determine an alert priority for each of the one or more device status messages;
a data store configured to store the alert priority from the alert generating unit, the respective device status message, and associated metadata;
an interactive user interface configured to provide a user with an alert message indicating the alert priority;
a monitoring unit configured to monitor and capture a user's interaction with the alert message at the interactive user interface;
a classification unit configured to classify the user's interaction with the alert message;
a heuristic/artificial intelligence/machine learning (HAIML) unit configured to store the user's interaction correlated with the corresponding alert message in a data store;
the HAIML unit configured to analyze the user's interaction and develop correlations between a cause of respective device status message, its associated data, and the user's interaction; and
the HAIML unit configured to update the data store with the correlation.

14. The system of claim 13, further including the alert generating unit configured to apply rules, filters, or algorithms associated with the monitored device.

15. The system of claim 14, including the HAIML unit configured to update the rules, filters, or algorithms based on respective ones of the correlations

16. The system of claim 15, including the alert generating unit configured to apply the updated rules, filters, or algorithms to respective ones of the device status messages.

17. The system of claim 13, including the HAIML unit configured to analyze the classification of the user's interaction.

18. The system of claim 13, including the alert generating unit configured to automatically act on a device status message prior to providing the alert message to the interactive user interface.
